(19) United States
(12) Patent Application Publication
(10) Pub. No.: US 2018/0350142 A1
(43) Pub. Date: Dec. 6, 2018

(54) THREE-DIMENSIONAL DATA PROCESSING APPARATUS AND THREE-DIMENSIONAL DATA PROCESSING METHOD

(71) Applicant: CANON KABUSHIKI KAISHA, Tokyo (JP)

(72) Inventor: Kenji Maruyama, Sydney (AU)

(21) Appl. No.: 16/059,131

(22) Filed: Aug. 9, 2018

Related U.S. Application Data
(63) Continuation of application No. PCT/JP2016/088998, filed on Dec. 27, 2016.

(30) Foreign Application Priority Data
Feb. 18, 2016 (JP) 2016-028736

(51) Int. Cl. G06T 17/20; G06T 19/20; G06T 15/00

(52) U.S. Cl. CPC G06T 17/205; G06T 19/20; G06T 15/005; G06T 2207/20101; G06T 2219/2021; G06T 2200/08; G06T 2219/012

(57) ABSTRACT

A three-dimensional data processing apparatus includes: a data acquiring unit configured to acquire data of a three-dimensional mesh model; a tolerance setting unit configured to set tolerance information for the three-dimensional mesh model; and a tolerance adding unit configured to generate three-dimensional data added with tolerance information which includes both the data of the three-dimensional mesh model and the data of the tolerance information.

### CROSS-REFERENCE TO RELATED APPLICATIONS

This application is a Continuation of International Patent Application No. PCT/JP2016/088998, filed Dec. 27, 2016, which claims the benefit of Japanese Patent Application No. 2016-028736, filed Feb. 18, 2016, both of which are hereby incorporated by reference herein in their entirety.

### BACKGROUND OF THE INVENTION

### Field of the Invention

The present invention relates to data representing a shape of a three-dimensional model, and a processing method thereof.

### Description of the Related Art

To perform three-dimensional tolerance analysis based on a three-dimensional model corresponding to a two-dimensional drawing, a method of adding tolerance information of the two-dimensional drawing to a corresponding shape of the three-dimensional model has been widely used. PTL 1 discloses a method of projecting a three-dimensional model to a two-dimensional drawing, and adding the tolerance information by specifying the shape of the three-dimensional model corresponding to the tolerance positions on the two-dimensional drawing.

### CITATION LIST

### Patent Literature

PTL 1: WO 2004/114165

In the case of the method according to PTL 1, the data of the three-dimensional model must be in a file format which allows storing the tolerance information, because the tolerance information of the two-dimensional drawing is added to the corresponding coordinates of the three-dimensional model. Therefore the three-dimensional model that is handled by the method according to PTL 1 is limited to three-dimensional CAD data. However, in manufacturing locations, a three-dimensional mesh model and a two-dimensional drawing are frequently used as a means of transferring design information, instead of using three-dimensional CAD data. The three-dimensional mesh model is a set of simple vertices, sides and surfaces, and cannot hold the tolerance information as in the case of the three-dimensional CAD data. This means that it has been difficult to use the data of the three-dimensional mesh model for the three-dimensional tolerance analysis.

With the foregoing in view, it is an object of the present invention to provide a technique to use the data of a three-dimensional mesh model for the three-dimensional tolerance analysis.

### SUMMARY OF THE INVENTION

A first aspect of the present invention provides a three-dimensional data processing apparatus, comprising: a data acquiring unit configured to acquire data of a three-dimensional mesh model; a tolerance setting unit configured to set tolerance information for the three-dimensional mesh model; and a tolerance adding unit configured to generate three-dimensional data added with tolerance information which includes both the data of the three-dimensional mesh model and the data of the tolerance information.

A second aspect of the present invention provides a three-dimensional data processing method, comprising: a step of operating a computer to read data of a three-dimensional mesh model from a storage device; a step of operating the computer to cause a user to input tolerance information to the three-dimensional mesh model; and a step of operating the computer to generate three-dimensional data added with tolerance information which includes both the data of the three-dimensional mesh model and the data of the tolerance information, and storing the generated three-dimensional data added with tolerance information in a storage device.

A third aspect of the present invention provides a non-transitory computer readable storing medium recording a computer program for causing a computer to perform a three-dimensional data processing method comprising: a step of operating a computer to read data of a three-dimensional mesh model from a storage device; a step of operating the computer to cause a user to input tolerance information to the three-dimensional mesh model; and a step of operating the computer to generate three-dimensional data added with tolerance information which includes both the data of the three-dimensional mesh model and the data of the tolerance information, and storing the generated three-dimensional data added with tolerance information in a storage device.

Further features of the present invention will become apparent from the following description of exemplary embodiments with reference to the attached drawings.

### BRIEF DESCRIPTION OF THE DRAWINGS

FIG. 1A is a diagram depicting an example of a functional configuration of a three-dimensional data processing apparatus according to Embodiment 1, and FIG. 1B is a diagram depicting an example of a hardware configuration of the three-dimensional data processing apparatus;

FIG. 2 is a flow chart depicting the data acquiring flow;

FIG. 3 is an example of a data structure of a three-dimensional mesh model;

FIG. 4A is a diagram depicting a display example of the two-dimensional drawing, and FIG. 4B is a diagram depicting a display example of the three-dimensional mesh model;

FIG. 5 is a flow chart depicting the tolerance setting flow;

FIG. 6A to FIG. 6D are diagrams depicting examples of a GUI of the tolerance settings;

FIG. 7 is a diagram depicting an example of a GUI of the tolerance settings;

FIG. 8A is an example of the data structure of dimensional tolerance information, and FIG. 8B is a diagram depicting an example of the tolerance display screen;

FIG. 9 is a flow chart depicting a flow of generating the three-dimensional data added with tolerance information;

FIG. 10 is an example of a data structure of a method of the three-dimensional data added with tolerance information;

FIG. 11 is a diagram depicting an example of a configuration of a three-dimensional processing apparatus according to Embodiment 2.

### DESCRIPTION OF THE EMBODIMENTS

Embodiments of the present invention will be described with reference to the accompanying drawings.

The configurations described in the following embodiments are merely examples, and the present invention is not limited to the illustrated configurations.

### Embodiment 1

(Apparatus Configuration)

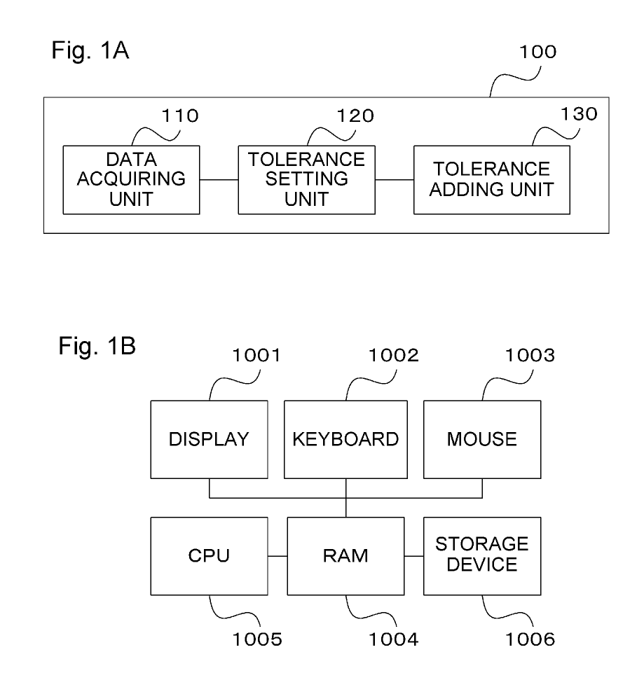

FIG. 1A is a diagram depicting an example of a functional configuration of a three-dimensional data processing apparatus to implement a three-dimensional data processing method according to Embodiment 1 of the present invention. The three-dimensional data processing apparatus 100 of Embodiment 1 includes three functional blocks: a data acquiring unit 110; a tolerance setting unit 120; and a tolerance adding unit 130.

FIG. 1B is a diagram depicting an example of a hardware configuration of the three-dimensional data processing apparatus 100. The three-dimensional data processing apparatus 100 can be configured using a general purpose computer, which includes a display 1001, a keyboard 1002, a mouse 1003, a RAM 1004, a CPU 1005 and a storage device 1006. This display 1001 is a device to display information (e.g. images) in accordance with the instructions from the CPU 1005. The keyboard 1002 is a device to input various information. The mouse 1003 is a device to specify an arbitrary position on the display 1001. The RAM (Random Access Memory) 1004 is a primary storage device which the CPU 1005 can directly access. The CPU (Central Processing Unit) 1005 is a processor to perform various numeric calculations, information processing operations, apparatus controls and the like using programs (not illustrated). The storage device 1006 is a storage which can store large capacity data, and is constituted by a hard disk or a semiconductor disk, for example. The storage device 1006 stores: programs to implement the three-dimensional data processing according to Embodiment 1; the three-dimensional mesh model and two-dimensional dimensional drawing used for the three-dimensional processing; the data of processing results and the like. Each functional block in FIG. 1A is implemented by loading the program, which is stored in the storage device 1006, to the RAM 1004, and the CPU 1005 executing this program.

The hardware configuration illustrated in FIG. 1B is merely an example, and the configuration of the present invention is not limited to this. For example, it is also preferable to use a touchpad or a touch panel as the input device, to use an external data server or online storage as the storage device, and to include a communication device which performs cable or wireless communication with another computer. Further, it is also preferable to configure the three-dimensional data processing apparatus 100 by a plurality of computers, or to add a dedicated processor (GPU: Graphic Processing Unit) especially designed for the three-dimensional data processing and image processing. Furthermore, a part or all of the functions of the three-dimensional data processing apparatus 100 may be replaced with such a circuit as an ASIC (Application Specific Integrated Circuit).

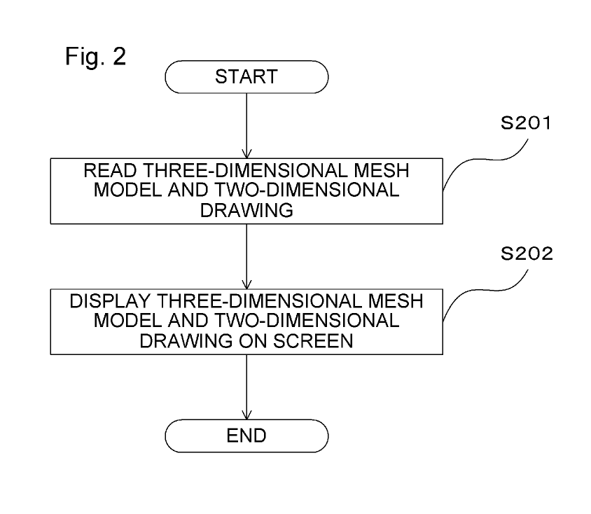

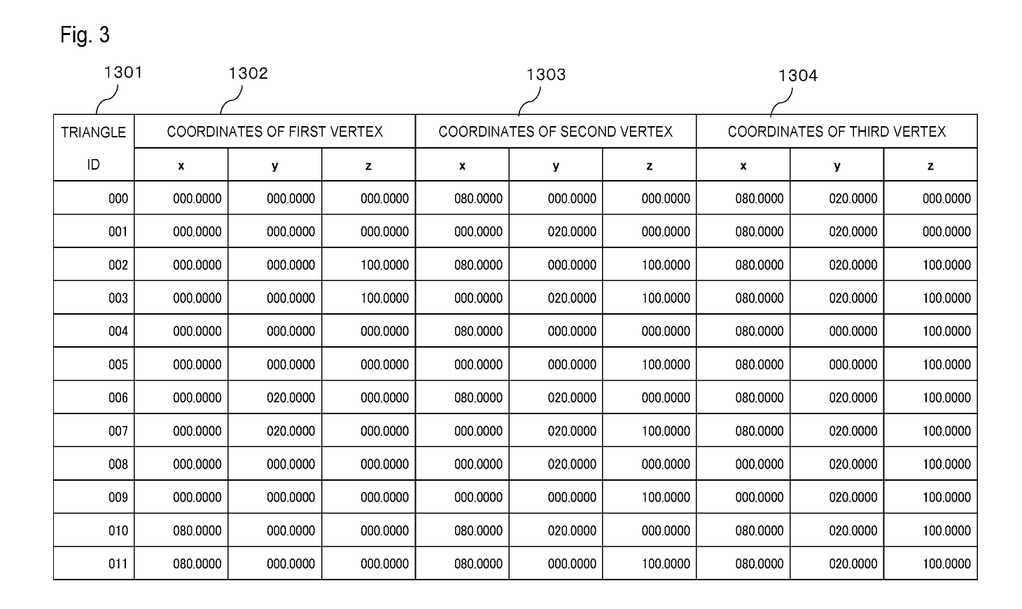

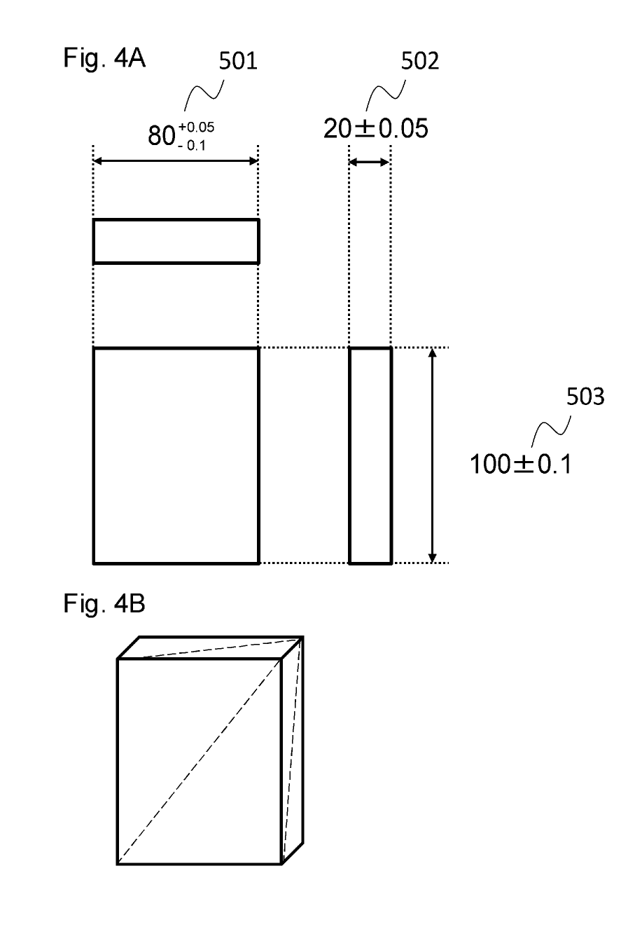

The data acquiring unit 110 is a processing unit which acquires the data of the three-dimensional mesh model and the data of the two-dimensional drawing from the storage device 1006, and displays an image of the three-dimensional mesh model and an image of the two-dimensional drawing on the screen of the display 1001. The three-dimensional mesh model is data representing the shape of the three-dimensional model using a set of vertices, sides (edges) and surfaces. Each surface constituting the three-dimensional mesh model is constituted of simple convex polygons, such as triangles and squares, and the three-dimensional mesh model is also called a “polygon mesh”. The two-dimensional drawing is data that includes information on a graphic generated by projecting a three-dimensional model to a two-dimensional plane (e.g. front view, side view, plan view), and information on tolerance. The storage device 1006 stores the data of the three-dimensional mesh mode and data of the two-dimensional drawing, which represent a same three dimensional mode, and are associated with each other. The method of acquiring the data will be described later with reference to FIG. 2, FIG. 3, FIG. 4A and FIG. 4B.

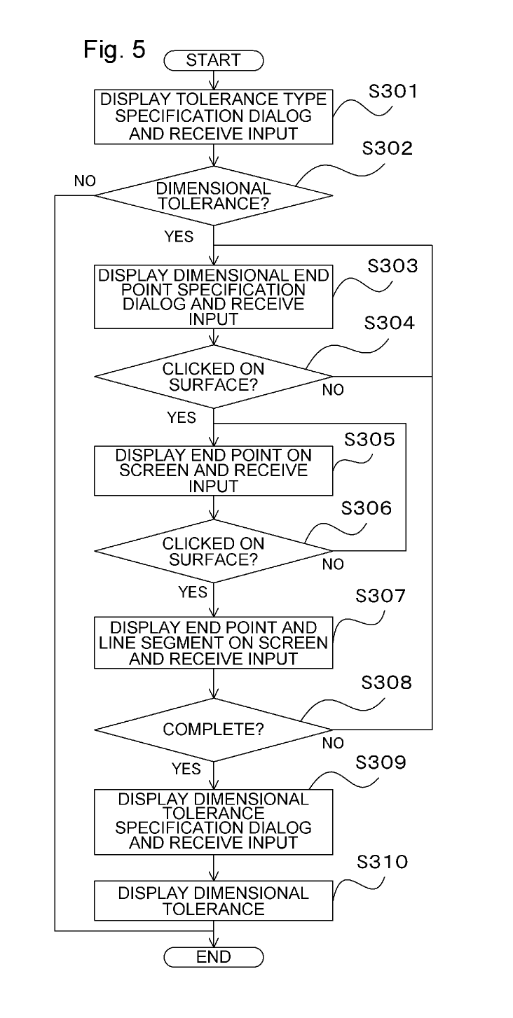

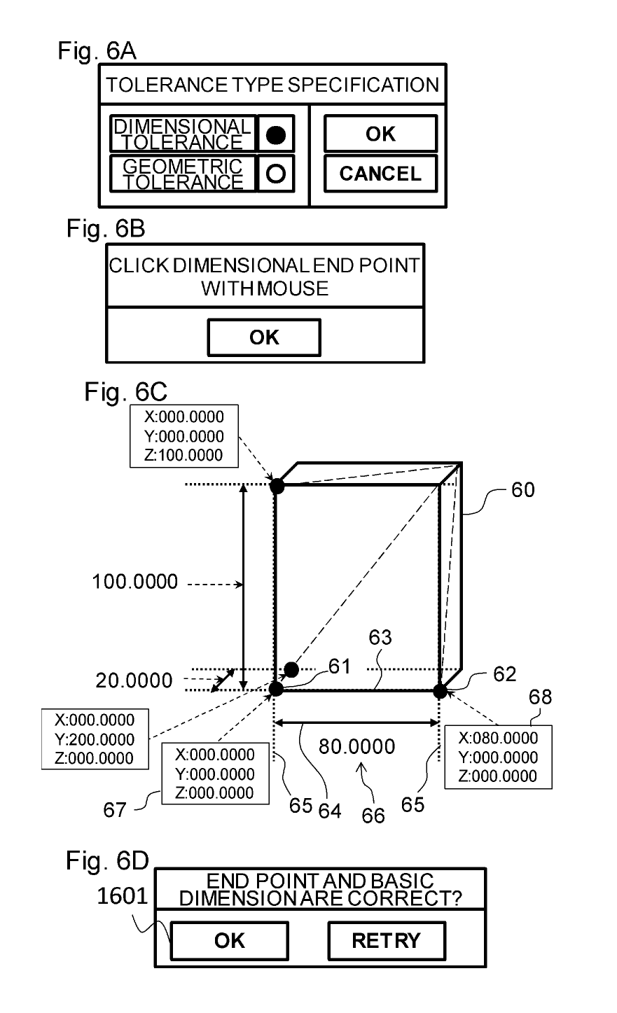

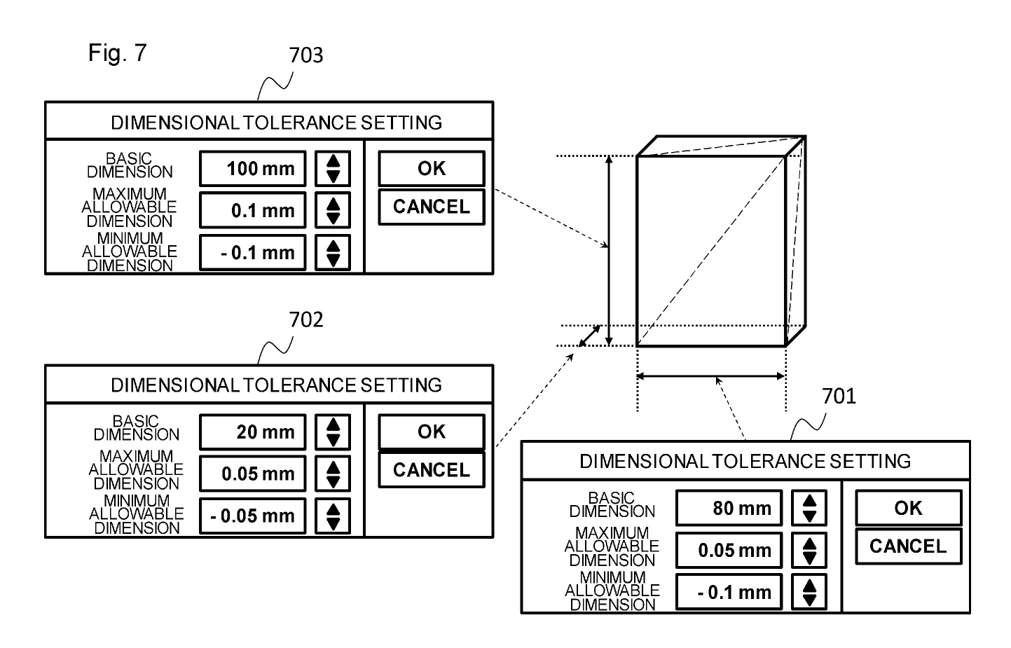

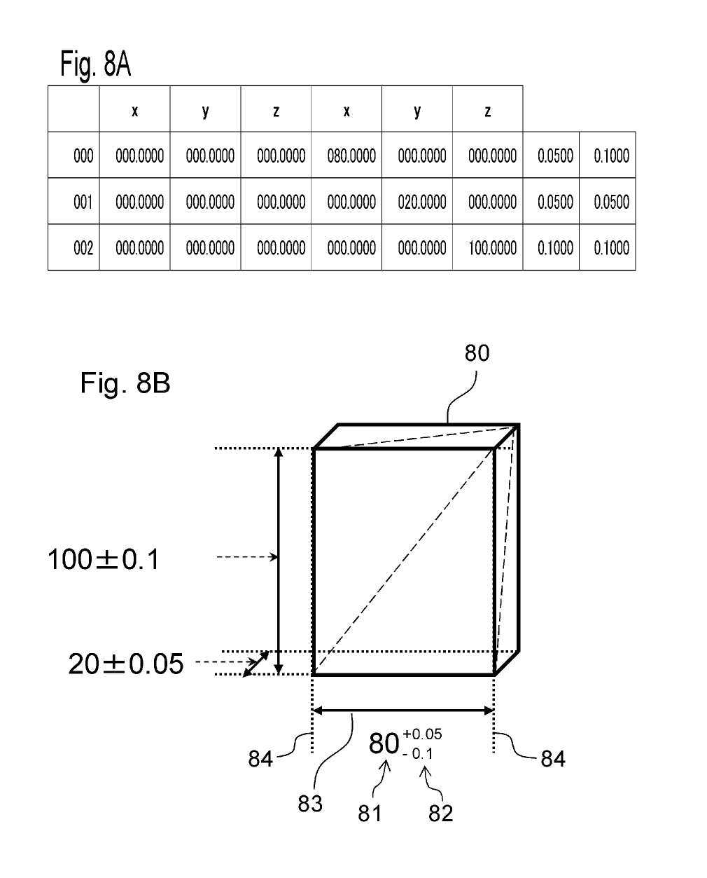

The tolerance setting unit 120 is a processing unit which sets the tolerance information for the three-dimensional mesh model. In Embodiment 1, the tolerance setting unit 120 provides the GUI and the input support function so that the user can input the tolerance information on the image of the three-dimensional mesh model displayed on the screen of the display 1001, by operating the keyboard 1002 and the mouse 1003. The method of setting the tolerance will be described later with reference to FIG. 5, FIG. 6A to FIG. 6D, FIG. 7, FIG. 8A and FIG. 8B.

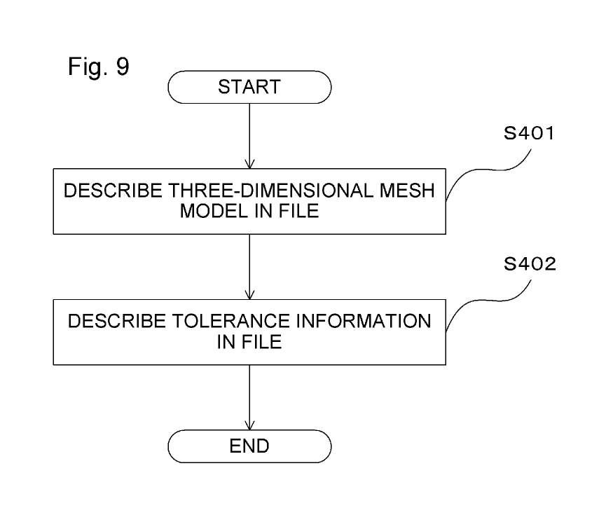

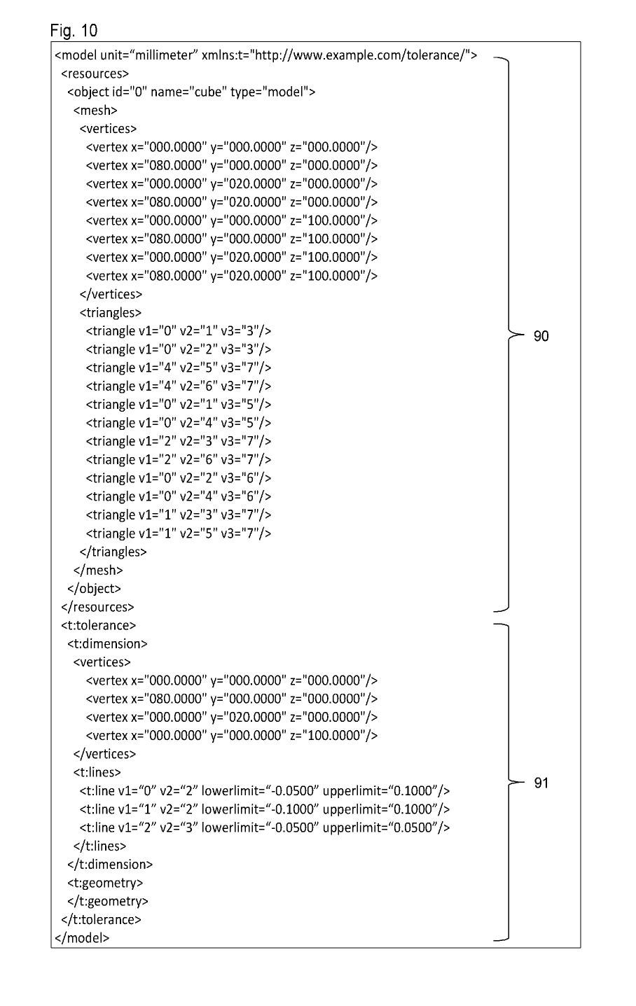

The tolerance adding unit 130 is a processing unit which stores the three-dimensional mesh model acquired by the data acquiring unit 110 and the tolerance information set by the tolerance setting unit 120, using a file format which allows storing the three-dimensional mesh model and the tolerance information at the same time. The tolerance adding method will be described later with reference to FIG. 9 and FIG. 10.

(Acquiring Data)

The method of acquiring data by the data acquiring unit 110 will be described next with reference to FIG. 2, FIG. 3, FIG. 4A and FIG. 4B. FIG. 2 is a flow chart depicting a data acquiring processing flow. FIG. 3 is an example of a data format of a three-dimensional mesh model, and FIG. 4A and FIG. 4B are display examples of the two-dimensional drawing and the three-dimensional mesh model respectively. In this description, a rectangular parallelopiped three-dimensional model is used as an example.

In step S201, the data acquiring unit 110 reads data of the three-dimensional mesh model and the data of the two-dimensional drawing, both of which represent the same three-dimensional model (rectangular parallelopiped in this example), from the storage device 1006, and stores this data in the RAM 1004. FIG. 3 is an example of the data of the three-dimensional mesh model stored in the RAM 1004. The reference number 1301 indicates an identifier of a polygon (triangle in this example) constituting the three-dimensional mesh model, and the reference numbers 1302, 1303 and 1304 indicate the coordinates of vertices constituting the polygon (three vertices of a triangle in this example). The data structure of the two-dimensional drawing may be any known data structure. For example, two-dimensional CAD data, such as DXF, may be used, or data generated by drawing software may be used. If the two-dimensional drawing is used only for referring to the information on dimensional tolerance, such image data formats as JPEG and PNG may be used (e.g. data generated by scanning a paper-based drawing or design sketch).

In step S202, the data acquiring unit 110 analyzes the input content stored in the RAM 1004, and displays the image of the three-dimensional mesh model and the image of the two-dimensional drawing on the screen of the display 1001. FIG. 4A is an example of an image of displaying the two-dimensional drawing on the screen of the display 1001. In FIG. 4A, the two-dimensional drawing is expressed by a front view, a right side view and a plan view. In each projection view, tolerance information 501, 502 or 503 (basic dimension, maximum allowable dimension and minimum allowable dimension in this example) is indicated. FIG. 4B is an example when an image viewing the three-dimensional mesh mode from a certain view point is displayed on the screen of the display 1001. The three-dimensional mesh model is a rectangular parallelopiped constituted of six rectangular surfaces, and each rectangle is constituted of two polygons (triangles), hence the three-dimensional mesh model is constituted of twelve polygons (triangles). The user can freely change the orientation (view point) of the three-dimensional mesh model.

It is preferable that the data acquiring unit 110 displays a window (also called a “pane”) to display the image of the three-dimensional mesh model and a window to display the image of the two-dimensional drawing side-by-side on the screen. This allows inputting the dimensional tolerance on the three-dimensional mesh model while referring to the dimensional tolerance displayed on the two-dimensional drawing, hence operability of the tolerance settings, described below, can be improved.

(Setting Tolerance)

The method of setting a tolerance by the tolerance setting unit 120 will be described next with reference to FIG. 5, FIG. 6A to FIG. 6D, FIG. 7, FIG. 8A and FIG. 8B. FIG. 5 is a flow chart depicting a tolerance setting processing flow. FIG. 6A to FIG. 6D and FIG. 7 are examples of the GUI for setting tolerance. FIG. 8A is an example of the data structure of dimensional tolerance, and FIG. 8B is an example of the tolerance display screen when the tolerance information is displayed on the three-dimensional mesh model.

In step S301, the tolerance setting unit 120 displays a tolerance type setting dialog (FIG. 6A) on the screen of the display 1001, and receives input from the user. The user can select either “dimensional tolerance” or “geometric tolerance” by operating the keyboard 1002 or the mouse 1003. The input content inputted by the user is stored in the RAM 1004.

In step S302, the tolerance setting unit 120 analyzes the input content stored in the RAM 1004, and determines whether the dimensional tolerance is specified. If it is determined that the dimensional tolerance is specified (YES in step S302), processing advances to step S303. If dimensional tolerance is not specified (NO in step S302), processing ends.

Steps S303 to S308 are processing for the user to specify a range to set the dimensional tolerance. In Embodiment 1, the user specifies points on both ends of the range to set the dimensional tolerance (first dimensional end point and second dimensional end point) on the image of the three-dimensional mesh model displayed on the screen of the display 1001. In concrete terms, in step S303, the tolerance setting unit 120 displays a dialog to request specification of the first dimensional end point (see FIG. 6B) on the screen of the display 1001, and receives input from the user. When the user specifies (e.g. clicks on) an arbitrary point on the screen using the mouse 1003, the tolerance setting unit 120 stores the input content in the RAM 1004, and processing advances to step S304.

In step S304, the tolerance setting unit 120 analyzes the input content stored in the RAM 1004, and determines whether the point specified in step S303 exists on the surface of the three-dimensional mesh model. If it is determined that the specified point is a point on the surface of the three-dimensional mesh model (YES in step S304), the tolerance setting unit 120 stores the coordinate values of this point in the RAM 1004 as the coordinate values of the first dimensional end point, and processing advances to step S305. If it is determined that the specified point is not a point on the surface of the three-dimensional mesh model, the tolerance setting unit 120 displays a dialog (not illustrated) to notify that the position specified as the dimensional end point is in appropriate, on the screen of the display 1001, and processing advances to step S303.

In step S305, the tolerance setting unit 120 calculates the display position of the first dimensional end point based on the coordinate values thereof stored in the RAM 1004, and displays the first dimensional end point superimposed on the three-dimensional mesh model. Further, the tolerance setting unit 120 displays a dialog to request specification of the second dimensional end point (see FIG. 6B) on the screen of the display 1001, and receives input from the user. When the user specifies (e.g. clicks on) an arbitrary point on the screen using the mouse 1003, the tolerance setting unit 120 stores the input content in the RAM 1004, and processing advances to step S306.

In step S306, the tolerance setting unit 120 analyzes the input content stored in the RAM 1004, and determines whether the point specified in step S305 exists on the surface of the three-dimensional mesh model. If it is determined that the specified point is a point on the surface of the three-dimensional mesh model (YES in step S306), the tolerance setting unit 120 stores the coordinate values of this point in the RAM 1004 as the coordinate values of the second dimensional end point, and processing advances to step S307. If it is determined that the specified point is not a point on the surface of the three-dimensional mesh model, the tolerance setting unit 120 displays a dialog (not illustrated) to notify that the position specified as the dimensional end point is inappropriate, on the screen of the display 1001, and processing advances to step S305.

In step S307, the tolerance setting unit 120 calculates the display position of the second dimensional end point based on the coordinate values thereof stored in the RAM 1004. Then the tolerance setting unit 120 displays the first dimensional end point 61, the second dimensional end point 62, and the line segment 63 connecting these dimensional end points superimposed on the three-dimensional mesh model 60, as illustrated in FIG. 6C. Further, the tolerance setting unit 120 calculates the basic dimension from the coordinate values of the first dimensional end point and the second dimensional end point, and displays a dimension line 64, an extension line 65, a value of the basic dimension 66, and the coordinate values 67 and 68 of the dimensional end points on the screen of the display 1001. Then the tolerance setting unit 120 displays a dialog (FIG. 6D) to confirm whether the dimensional end points and the basic dimension are correctly set or not on the screen of the display 1001, and receives input from the user. The input content inputted by the user is stored in the RAM 1004. To set the dimensional tolerances at a plurality of locations of the three-dimensional mesh model, the operations in steps 5303 to 5307 are repeated a required number of times. FIG. 6C is an example when dimensions at three locations (width, depth, height) of the rectangular parallelopiped (three sets of dimensional end points) are set.

In step S308, the tolerance setting unit 120 analyzes the input content stored in the RAM 1004, and determines whether the OK button 1601 was pressed. If it is determined that the OK button 1601 was pressed, processing advances to step S309. If it is determined that the OK button 1601 was not pressed, processing advances to step S303.

In step S309, the tolerance setting unit 120 displays a dimensional tolerance setting dialog (FIG. 7) on the screen of the display 1001, and receives input from the user. When the user inputs the basic dimension, maximum allowable dimension and minimum allowable dimension using the keyboard 1002 or mouse 1003, the input content is stored in the RAM 1004.

FIG. 7 is a display example of the dimensional tolerance setting dialogs. In the setting dialog 701, the user sets the 80 mm basic dimension, the 0.05 mm maximum allowable dimension, the −0.1 mm minimum allowable dimension for the width of the rectangular parallelopiped. In the setting dialog 702, the user set the 20 mm basic dimension, the 0.05 mm maximum allowable dimension and the −0.05 mm minimum allowable dimension for the depth of the rectangular parallelopiped. And in the setting dialog 703, the user set the 100 mm basic dimension, the 0.1 mm maximum allowable dimension and the −0.1 mm minimum allowable dimension for the height of the rectangular parallelopiped.

FIG. 8A indicates the data structure of the dimensional tolerance information stored in the RAM 1004. The dimensional tolerance information includes the coordinate values of the first dimensional end point, the coordinate values of the second dimensional end point, the maximum allowable dimension, and the minimum allowable dimension. The data 000, 001 and 002 are dimensional tolerance information which were set in the setting dialogs 701, 702 and 703 in FIG. 7 respectively.

In step S310, the tolerance setting unit 120 displays the basic dimension 81 and the allowable dimension 82 superimposed on the three-dimensional mesh model 80, as indicated in FIG. 8B, based on the dimensional tolerance information stored in the RAM 1004. The tolerance setting unit 120 also displays the dimensional line 83 and the extension line 84 if necessary.

(Generating Three-Dimensional Data Added with Tolerance Information)

The method of generating the three-dimensional data added with tolerance information by the tolerance adding unit 130 will be described next with reference to FIG. 9 and FIG. 10. FIG. 9 is a flow chart depicting the processing flow of the method of generating the three-dimensional data added with tolerance information. FIG. 10 is an example of the data structure of the three-dimensional data added with tolerance information. The three-dimensional data added with tolerance information is data having a unique file format, which allows writing both the data of the three dimensional mesh model 90 and the data of the tolerance information 91 in one file.

In step S401, the tolerance adding unit 130 writes the data of the three-dimensional mesh model (FIG. 3), which was stored in the RAM 1004 by the data acquiring unit 110, to a file. The portion indicated by the reference number 90 in FIG. 10 is the description example of the data of the three-dimensional mesh model.

The “model” element is a root element of at least one three-dimensional model used for the three-dimensional shaping processing. The “unit” attribute in the “model” element indicates the unit of the length used for the “model” element. In the description example in FIG. 10, millimeter (mm) is specified. The “xmlns” attribute in the model element specifies the DTD (Document Type Definition) to refer to the definition of the tag and the attribute. In the description example in FIG. 10, an identifier “http://www.example.com/tolerance/” is specified for the “xmlns” attribute of the <t> tag. By referring to the document specified by this URL, the definition of the description of the data of the tolerance information can be acquired.

The “resource” element is a parts information of the three-dimensional model and the materials required for the three-dimensional shaping (additive manufacturing).

The “object” element indicates one three-dimensional model that can be shaped. The “id” attribute in the “object” element indicates an identifier of the three-dimensional model, the “name” attribute indicates a name of the three-dimensional model, and the “type” attribute indicates a role which the three-dimensional model plays when the three-dimensional shaping is performed (“model”: model material, “support”: support material, “other”: other materials). The “type” attribute is information to specify the shaping material that is used for the three-dimensional shaping, for example. In the description example in FIG. 10, “0”, “cube” and “model” are specified respectively.

The “mesh” element is a root element of a triangular mesh.

The “vertices” element includes all the “vertex” elements used for the mesh element. The “vertex” element indicates a vertex (an end point of the edge of the triangular mesh). In the description example in FIG. 10, the three-dimensional mesh model is constituted of eight vertices, hence it is described by a “vertices” element constituted of eight “vertex” elements having coordinates of a vertex (x attribute, y attribute, z attribute).

The “triangles” element includes all the “triangle” elements used for the “mesh” element. The “triangle” element indicates one triangle. In the description in FIG. 10, the three-dimensional mesh model is a rectangular parallelopiped constituted of six rectangle faces, and each rectangle is constituted of two triangles, hence the three-dimensional mesh model is constituted by twelve triangles. Therefore in the “triangles” element, twelve “triangle” elements, each of which has three vertices (v1 attribute, v2 attribute, v3 attribute), are written. Each of the numeric values specified by the v1 attribute, v2 attribute and v3 attribute is an index value of the vertex element (0, 1, . . . , 7 in descending order).

Then in step S402, the tolerance adding unit 130 writes the data of the dimensional tolerance (FIG. 8A), which was stored in the RAM 1004 by the tolerance setting unit 120. This file is written in the storage device 1006. The portion indicated by the reference number 91 in FIG. 10 is the description example of the data of the tolerance information.

The t: tolerance” element is a root element of the tolerance information. The tolerance information includes two sections: dimensional tolerance information (t: dimension) and geometric tolerance information (t: geometry).

The “t: dimension” element is a root element of the dimensional tolerance information. The dimension tolerance information includes two sections: vertex information (vertices) and segment information (t: lines). The “vertices” element includes all the “vertex” elements used for the “dimension” element. The “vertex” element indicates an end point of the base dimension in the dimensional tolerance. The coordinates of the four dimensional end points indicated in FIG. 6C are written in the description example in FIG. 10. The “t: lines” element includes all the “t: line” elements used for the “dimension” element. The “t: line” element indicates the base dimension and the allowable critical dimension in the dimensional tolerance. In concrete terms, the “t: line” element indicates both end points to express the base dimension, the maximum allowable dimension and the minimum allowable dimension. Both end points, the maximum allowable dimension and the minimum allowable dimension in the dimensional tolerance indicated in FIG. 8A are written in the description example in FIG. 10.

The “t: geometry” element is a root element of the geometric tolerance. The geometric tolerance is information to specify the allowable error of the shape of the three-dimensional model. The geometric tolerance includes, for example, straightness, flatness, roundness, parallelism, squareness, simultaneousness, concentricity and symmetry. In Embodiment 1, the user does not specify the geometric tolerance, hence information on the geometric tolerance is blank from the <geometry> tag to the </geometry> tag in the description example in FIG. 10. If the user specifies the geometric tolerance, such information as the type of geometric tolerance and value thereof is written.

(Advantages of Embodiment 1)

The advantages of Embodiment 1 described above are as follows. Since the three-dimensional data added with tolerance information is used, the three-dimensional mesh model representing the shape of the three-dimensional model and the tolerance information to specify the tolerance thereof can be handled in one file. Therefore the three-dimensional mesh model can be used for the three-dimensional tolerance analysis. Further, the three-dimensional data added with tolerance information can be generated from the data of the three-dimensional mesh model and the data of the two-dimensional drawing, which have often been used as a means of transferring the design information in actual manufacturing locations, this makes using three-dimensional CAD data unnecessary, which is highly practical.

If the three-dimensional data processing apparatus of Embodiment 1 is used, the tolerance information can be inputted on the image of the three-dimensional mesh model displayed on the screen, therefore the tolerance information can be easily set for the three-dimensional mesh model. For example, the dimensional end point can be specified intuitively by specifying (clicking on) an arbitrary point on the image of the three-dimensional mesh model using the mouse. Further, the tolerance information can be inputted for the three-dimensional mesh model while referring to the image of the two-dimensional drawing in which the tolerance information is added, hence operability improves and input errors decrease.

The three-dimensional data added with tolerance information of Embodiment 1 includes information to specify the shaping material used for the three-dimensional shaping (“type” attribute in “object” element), therefore the three-dimensional data added with tolerance information is suitable for the three-dimensional shaping, such as a 3D printer. Further, the data of the three-dimensional mesh model and the data of the tolerance information are written in separate sections, hence the application side can extract and use only the section of the data of the three-dimensional mesh model, or only the section of the tolerance information. For example, if the application is for the three-dimensional shaping (e.g. slicer), then only the data of the three-dimensional mesh model may be read, and if the application is for the three-dimensional tolerance analysis, both the data of the three-dimensional mesh mode and the data of the tolerance information may be read. By separating into sections, the three-dimensional data added with tolerance information can have upward compatibility with the three-dimensional mesh model, and even an application that does not support the tolerance information can at least read the data of the three-dimensional mesh model. Further, the three-dimensional data added with tolerance information includes information on the definition of the data description of the tolerance information (“xmlns” attribute), hence even if the application does not support the tolerance information, the information specified by the “xmlns” attribute can be referred to, whereby the tolerance information can be used.

### Embodiment 2

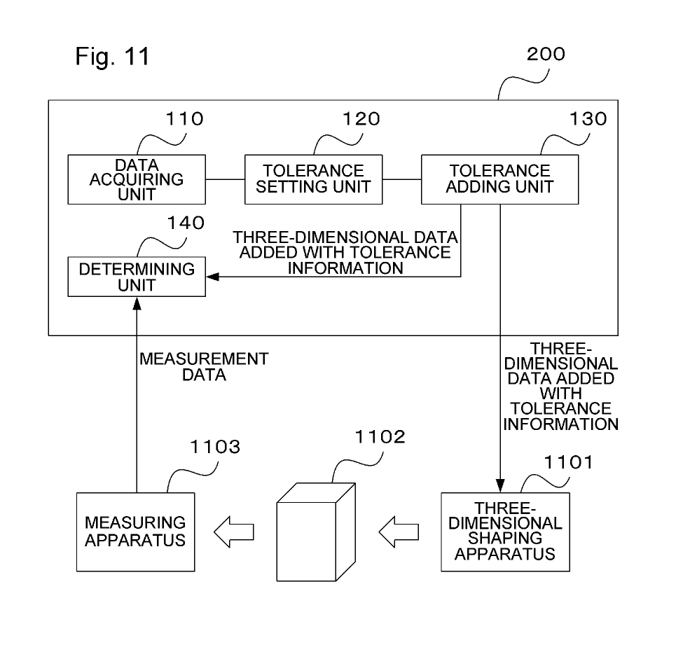

FIG. 11 is a diagram depicting an example of the functional configuration of a three-dimensional data processing apparatus which implements a three-dimensional data processing method according to Embodiment 2 of the present invention. The three-dimensional data processing apparatus 200 of Embodiment 2 has four functional blocks: a data acquiring unit 110, a tolerance setting unit 120, a tolerance adding unit 130, and a determining unit 140. The functions of the data acquiring unit 110, the tolerance setting unit 120 and the tolerance adding unit 130 are the same as those of Embodiment 1, therefore mainly the functions of the determining unit 140 will be described.

The determining unit 140 is a processing unit that evaluates the dimensional accuracy of a three-dimensional shaping object created based on the three-dimensional data added with tolerance information. For example, as illustrated in FIG. 11, it is assumed that a three-dimensional shaping apparatus 1101 created a three-dimensional shaping object 1102 based on the three-dimensional data added with tolerance information provided by the three-dimensional data processing apparatus 200. In order to inspect whether the three-dimensional shaping object 1102 was precisely created with the shape and dimensions according to design (as the three-dimensional mesh model), the actual size of the three-dimensional shaping object 1102 is measured by a measuring apparatus 1103, such as a three-dimensional scanner. Then the three-dimensional measurement data acquired by the measuring apparatus 1103 is inputted to the determining unit 140. The determining unit 140 performs such analyzing processing as searching the corresponding points between the measurement data and the three-dimensional mesh model, included in the three-dimensional data added with tolerance information, so as to map the measurement data in the same three-dimensional space as the three-dimensional mesh model. Then the determining unit 140 compares the actual dimensions determined based on the measurement data and the basic dimensions and the tolerance specified in the tolerance information, and determines whether the dimensions of the three-dimensional shaping object 1102 is within the range of the tolerance. If the dimensions of the three-dimensional shaping object 1102 are outside the range of the tolerance, this three-dimensional shaping object 1102 is treated as a defective object, for example. The determination result of the determining unit 140 is displayed on the screen of the display 1001. This determination result may be fed back to the three-dimensional shaping apparatus 1101 for parameter adjustment and calibration of the three-dimensional shaping apparatus 1101.

According to the configuration of Embodiment 2 described above, the three-dimensional data added with tolerance information can be used for both the three-dimensional shaping and inspection thereof, which enhances convenience.

### Other embodiments

Examples of embodiments have been described, but the present invention may be implemented as a system, apparatus, method, program, recording medium (storage medium) or the like. In concrete terms, the present invention may be applied to a system constituted of a plurality of devices (e.g. host computer, interface apparatus, imaging apparatus, web application), or may be applied to an apparatus constituted of one device.

Needless to say, the object of the present invention will be achieved by the following. That is, a recording medium (or storage medium) recording software-based program codes (computer programs), to implement the above mentioned functions of the embodiments, is supplied to the system or apparatus. This storage medium is a computer-readable storage medium. Then the computer (or CPU or MPU) of the system or apparatus reads and executes the program codes stored in the storage medium. In this case, the program codes that are read from the storage medium implement the above mentioned functions of the embodiments, and the storage medium storing the program codes is regarded as a part of the present invention.

The GUI used in the above embodiments allows specifying an arbitrary position on the surface of the three-dimensional model as a dimensional end point. However, a GUI or an input support function to specify (select) a dimensional endpoint from vertices or points on the sides constituting the three-dimensional mesh model may be used, since tolerance is normally set between points or between sides. For example, when the user specifies (clocks on) an arbitrary point using the mouse, a vertex or a point on a side closest to the specified point is extracted, and this extracted point is set as the dimensional end point. By using this input support function, a vertex or a point on a side can be easily specified.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

According to the present invention, data of a three-dimensional mesh model can be used for the three-dimensional tolerance analysis.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. A three-dimensional data processing apparatus, comprising:
a data acquiring unit configured to acquire data of a three-dimensional mesh model;
a tolerance setting unit configured to set tolerance information for the three-dimensional mesh model; and
a tolerance adding unit configured to generate three-dimensional data added with tolerance information which includes both the data of the three-dimensional mesh model and the data of the tolerance information.

2. The three-dimensional data processing apparatus according to claim 1, wherein
the data acquiring unit displays an image of the three-dimensional mesh model, based on the data of the three-dimensional mesh model, on a screen of display, and
the tolerance setting unit allows a user to input, on the displayed image of the three-dimensional mesh model, the tolerance information.

3. The three-dimensional data processing apparatus according to claim 2, wherein the tolerance setting unit allows the user to input a position, where the tolerance information is set, by the user specifying an arbitrary point on the image of the three-dimensional mesh model.

4. The three-dimensional data processing apparatus according to claim 2, wherein the data acquiring unit acquires data of a two-dimensional drawing which includes information on a graphic generated by projecting a three-dimensional model that is the same as the three-dimensional mesh model on a two-dimensional plane, and tolerance information, and displays an image of a two-dimensional drawing on which the tolerance information is displayed based on the data of the two-dimensional drawing, on the screen of display together with the image of the three-dimensional mesh model.

5. The three-dimensional data processing apparatus according to claim 1, wherein the three-dimensional data added with tolerance information includes information on dimensional tolerance and/or information on geometric tolerance, as the tolerance information.

6. The three-dimensional data processing apparatus according to claim 5, wherein the information on the dimensional tolerance includes: coordinates values of a first dimensional end point and a second dimensional end point which are points at both ends of a range in which the dimensional tolerance is set; a value of a maximum allowable dimension; and a value of a minimum allowable dimension.

7. The three-dimensional data processing apparatus according to claim 1, wherein
the three-dimensional data added with tolerance information is data used for three-dimensional shaping, and
the three-dimensional data added with tolerance information includes information for specifying a shaping material used for the three-dimensional shaping.

8. The three-dimensional data processing apparatus according to claim 1, wherein the data of the three-dimensional mesh model and the data of the tolerance information are written in separate sections in the three-dimensional data added with tolerance information.

9. The three-dimensional data processing apparatus according to claim 1, wherein the three-dimensional data added with tolerance information includes information on a definition of data description of the tolerance information.

10. The three-dimensional data processing apparatus according to claim 1, further comprising a determining unit configured to acquire measurement data acquired by measuring a three-dimensional shaping object created based on the three-dimensional data added with tolerance information, and determine whether dimensions of the three-dimensional shaping object is within the tolerance range by comparing the measurement data and the data of the tolerance information included in the three-dimensional data added with tolerance information.

11. A three-dimensional data processing method, comprising:
a step of operating a computer to read data of a three-dimensional mesh model from a storage device;
a step of operating the computer to cause a user to input tolerance information to the three-dimensional mesh model; and
a step of operating the computer to generate three-dimensional data added with tolerance information which includes both the data of the three-dimensional mesh model and the data of the tolerance information, and storing the generated three-dimensional data added with tolerance information in a storage device.

12. A non-transitory computer readable storing medium recording a computer program for causing a computer to perform a three-dimensional data processing method comprising:
a step of operating a computer to read data of a three-dimensional mesh model from a storage device;
a step of operating the computer to cause a user to input tolerance information to the three-dimensional mesh model; and
a step of operating the computer to generate three-dimensional data added with tolerance information which includes both the data of the three-dimensional mesh model and the data of the tolerance information, and storing the generated three-dimensional data added with tolerance information in a storage device.
